(19) United States
(12) Patent Application Publication
(10) Pub. No.: US 2026/0141570 A1
(43) Pub. Date: May 21, 2026

(54) METHOD AND COMPUTING DEVICE FOR COMPRESSED 3D GAUSSIAN SPLATTING, AND COMPUTER-READABLE RECORDING MEDIUM THEREOF

(71) Applicants: RESEARCH & BUSINESS FOUNDATION SUNGKYUNKWAN UNIVERSITY, Suwon-si (KR); ELECTRONICS AND TELECOMMUNICATIONS RESEARCH INSTITUTE, Daejeon (KR)

(72) Inventors: Eunbyung PARK, Suwon-si (KR); Jong Hwan KO, Suwon-si (KR); Joo Chan LEE, Suwon-si (KR); Daniel RHO, Suwon-si (KR); Xiangyu SUN, Suwon-si (KR); Jun Young JEONG, Daejeon (KR); Gwangsoon LEE, Daejeon (KR)

(21) Appl. No.: 19/395,872

(22) Filed: Nov. 20, 2025

(30) Foreign Application Priority Data
Nov. 21, 2024 (KR) 10-2024-0167744

(51) Int. Cl. G06T 9/00; G06T 7/62; G06T 7/90

(52) U.S. Cl. CPC G06T 9/002; G06T 7/62; G06T 7/90; G06T 2200/04; G06T 2207/10024; G06T 2207/20081; G06T 2207/20084

(57) ABSTRACT

The present disclosure provides a method for a compressed 3D scene representation that is capable of high-quality, real-time rendering while significantly reducing storage space, by removing unnecessary Gaussians with a trainable masking based on volume and opacity in 3D Gaussian Splatting (3DGS) technology, compressing geometric attributes with a codebook based on residual vector quantization, representing view-dependent colors with a grid-based neural field, and processing even dynamic scenes with space-time masking and a polynomial representation of motion.

### CROSS-REFERENCE TO RELATED APPLICATION

This application claims priority to Korean Patent Application No. 10-2024-0167744, filed on Nov. 21, 2024 in the Korean Intellectual Property Office, the disclosure of which is incorporated herein by reference.

### BACKGROUND OF THE DISCLOSURE

### Field of the Disclosure

The present disclosure relates to a technology based on 3D Gaussian Splatting (3DGS) that improves existing problems of storage space and rendering speed.

### Description of the Related Art

In the related art, various methods for capturing and reconstructing 3D scenes have been proposed. Among them, Neural Radiance Fields (NeRF) has gained attention as a groundbreaking method that can reconstruct high-quality 3D scenes from 2D images. However, NeRF had a limitation in that real-time rendering was difficult due to a computational bottleneck caused by per-pixel volume rendering.

To overcome this limitation, 3D Gaussian Splatting (3DGS) was proposed. 3DGS achieved both real-time rendering and high-quality image generation by introducing a point-based representation, which utilizes 3D Gaussian attributes, and a rasterization pipeline. In particular, it realized unprecedented rendering speeds through highly optimized CUDA kernels and algorithmic techniques.

However, 3DGS has a significant drawback in that it requires a considerably large number of Gaussians to maintain the high quality of rendered images. Each Gaussian has multiple attributes, such as position, scale, rotation, color, and opacity, requiring more than 1 GB of large memory and storage space to represent a real scene. For dynamic scenes, the burden on storage space is further increased as additional attributes are needed to model movement over time.

Recently, various compression techniques have been proposed to solve this problem. Methods have been studied that utilize traditional compression techniques such as scalar or vector quantization and entropy coding, or that remove Gaussians with low importance after training. However, most methods perform compression as a post-training process, and there was a difficulty in evaluating the importance of Gaussians over the entire time period, especially in dynamic scenes.

Furthermore, existing methods failed to utilize spatial redundancy by storing the attributes of each Gaussian individually. For example, even though adjacent Gaussians may have similar color attributes, this was not effectively utilized. The spherical harmonics coefficients used to represent color changes according to the viewpoint also became a cause of occupying a large amount of storage space.

Against this backdrop, the need for a new method has emerged that can efficiently reduce storage space while maintaining the high-quality expressive power of 3d scenes. In particular, there was a demand for the development of an integrated framework that considers efficiency from a training process and is applicable to both static and dynamic scenes.

### SUMMARY OF THE DISCLOSURE

Therefore, the present disclosure has been made in view of the above problems, and it is an object of the present disclosure to provide a compressed 3D scene representation method capable of high-quality real-time rendering while significantly reducing the storage space for static and dynamic 3D scenes, by effectively removing unnecessary Gaussians with a trainable volume masking in 3D Gaussian Splatting (3DGS) and efficiently storing Gaussian attributes through codebook-based compression and a grid-based neural field.

In accordance with an aspect of the present disclosure, the above and other objects can be accomplished by the provision of a method for compressed 3D Gaussian Splatting (3DGS), the method including: a first step of initializing 3D Gaussians from multi-view 2D images; a second step of generating trainable mask parameters based on a volume and opacity of each Gaussian; a third step of removing Gaussians whose impact on rendering quality is below a threshold based on the mask parameters; a fourth step of compressing geometric attributes of remaining Gaussians based on a codebook; and a fifth step of representing view-dependent colors of the remaining Gaussians with a grid-based neural field.

The second step may include: generating a binary mask for a scale attribute and opacity attribute that determine the volume of each Gaussian; and calculating a masked covariance matrix and opacity based on the binary mask.

The fourth step may include: compressing scale and rotation attributes of the Gaussians using multi-stage residual vector quantization; and storing a codebook index for each stage.

The fifth step may include: constructing a hash-based multi-resolution grid structure; and training a neural network that extracts color features using a position and view direction of a Gaussian as input.

The method may further include, for processing a dynamic scene: representing movement of a Gaussian over time with polynomial coefficients; calculating time-conditional visibility based on a temporal center and a scale; and applying space-time masking to remove a Gaussian with low importance over an entire time interval.

In the dynamic scene processing, residual vector quantization may be applied to temporal features and motion coefficients for compression; and static color features may be represented with a grid-based neural field.

In accordance with another aspect of the present disclosure, there are provided a computing device for implementing the compressed 3DGS method, and a computer-readable recording medium having recorded thereon a program for causing a computer to execute the method.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 schematically illustrates a process of masking Gaussians that have a minimal impact on performance during an optimization process;

FIG. 2 illustrates a flowchart of a compressed 3D Gaussian Splatting (3DGS) method of the present disclosure:

FIG. 3 illustrates a residual vector quantization (R-VQ) process for representing the scale and rotation of the Gaussian;

FIG. 4 illustrates a detailed architecture of a compressed Gaussian representation for dynamic scenes;

FIG. 5 illustrates visual results comparing 3DGS and the present disclosure, and displays a PSNR value, which indicates rendering quality, and required storage space together for each result; and

FIG. 6 illustrates the block diagram of a computing device for implementing the compressed 3DGS method of the present disclosure.

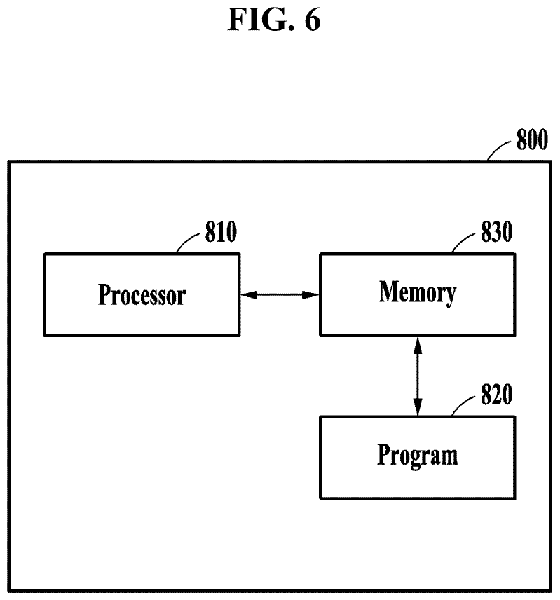

### DETAILED DESCRIPTION OF THE DISCLOSURE

Hereinafter, embodiments of the present disclosure will be described in detail with reference to the accompanying drawings. However, in the following description and the accompanying drawings, detailed descriptions of known functions or configurations that may obscure the subject matter of the present disclosure will be omitted. In addition, throughout this specification, when an element is described as “comprising” a component, it means that the element may include other components, not excluding them, unless specifically stated otherwise.

Furthermore, terms such as “first” and “second” may be used to describe various components, but the components should not be limited by these terms. These terms may be used for the purpose of distinguishing one component from another. For example, a first component may be referred to as a second component, and similarly, a second component may be referred to as a first component, without departing from the scope of the present disclosure.

The terminologies used in the present disclosure are for the purpose of describing particular embodiments only and is not intended to be limiting of the present disclosure. A singular expression includes a plural expression unless the context clearly indicates otherwise. In this application, terms such as “comprising” or “having” are intended to specify the presence of stated features, numbers, steps, operations, elements, components, or combinations thereof, and should not be construed as precluding the possibility of the presence or addition of one or more other features, numbers, steps, operations, elements, components, or combinations thereof.

Unless otherwise defined, all terms used herein, including technical or scientific terms, have the same meaning as commonly understood by one of ordinary skill in the art to which the present disclosure belongs. Terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure will be described. First, 3D Gaussian Splatting (3DGS), which is the basis of the present disclosure, will be described, followed by a description of the present disclosure.

### 3D Gaussian Splatting (3DGS)

3D Gaussian Splatting (3DGS) uses a point-based representation method associated with 3D Gaussian attributes to represent a 3D scene. Specifically, N Gaussians are defined by the following attributes:
Center position (p): Coordinate values in RN×3 space
Opacity (o): Scalar value in [0,1]N range
3D scale(s): Positive real value in RN×3+space
3D rotation (r): Quaternion value in RN×4 space
Spherical harmonics coefficient (h): View-dependent color value in RN×48 space

The covariance matrix (Σₙ) of each Gaussian is a positive semi-definite matrix, and is calculated by the following equation:

$${Σ}_{n} = R ( {r}_{n} ) S ( {s}_{n} ) {S ( {s}_{n} )}^{T} {R ( {r}_{n} )}^{T} \qquad [ Equation 1 ]$$

where R(⋅) is a function that generates a rotation matrix from a quaternion, and S(⋅) is a function that generates a diagonal scale matrix from a 3D scale.

For image rendering, 3D Gaussians are projected into 2D space by a view transformation matrix (W) and the Jacobian (J) of the affine approximation of projection transformation, where the projected 2D covariance matrix (Σ′ₙ), which determines the Gaussian shape in 3D space, is expressed as in the following Equation 2:

$${Σ}_{n}^{′} = JW {Σ}_{n} {W}^{T} {J}^{T} \qquad [ Equation 2 ]$$

where J is the Jacobian matrix of the affine approximation of projection transformation (representing transformation in a projection process from 3D to 2D), W is a view transformation matrix (representing 3D transformation according to a camera viewpoint), and W^{T} and J^{T} are the transpose matrices of W and J, respectively.

The color of each pixel in the image is rendered as shown in the following Equations 3 and 4 through alpha blending that uses the color calculated from spherical harmonics and the final opacity in 2D space:

$$C ( x ) = {\sum }_{k = 1}^{𝒩 ( x )} {c}_{k} {α}_{k} ( x ) {\prod }_{j = 1}^{k - 1} ( 1 - {α}_{j} ( x ) ) \qquad [ Equation 3 ]$$

$${α}_{n} ( x ) = {o}_{n} exp ( - \frac{1}{2} {( x - {p}_{n}^{′} )}^{T} {Σ}_{n}^{′ - 1} ( x - {p}_{n}^{′} ) ) \qquad [ Equation 4 ]$$

where x is a pixel coordinate, N₍ₓ₎ is the number of Gaussians around that pixel, p′ₙ is a projected Gaussian center position, and the Gaussians are sorted based on depth according to the view direction.

3DGS constructs initial 3D Gaussians from sparse points obtained from the Structure-from-Motion (SfM) technique. These Gaussians then undergo a process of cloning, splitting, removing, and refining for an accurate representation of the scene. This training process is based on gradients from differentiable rendering while avoiding unnecessary computations in empty areas, thereby improving training and rendering speeds.

While this basic configuration of 3DGS enables effective real-time rendering, it has a limitation in that a large number of Gaussians and their corresponding attributes are required for high-quality reconstruction, thus demanding significant memory and storage space.

### PRESENT DISCLOSURE

The main objectives of the present disclosure are 1) to reduce the number of Gaussians without sacrificing performance and 2) to represent attributes compressively.

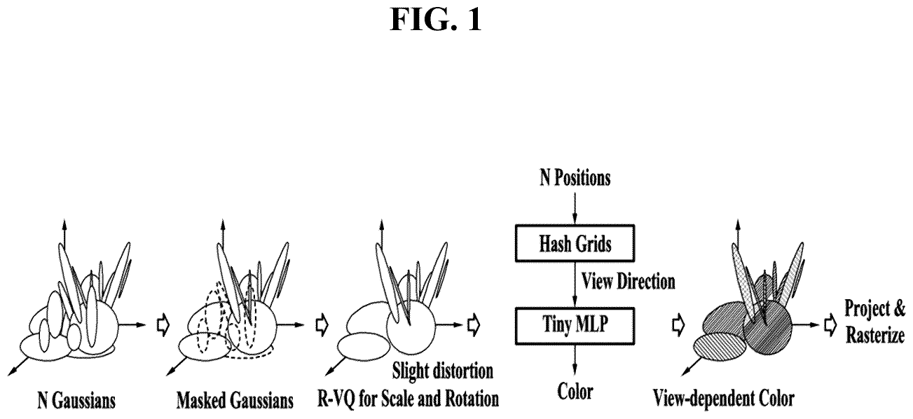

To realize this, as shown in FIG. 1, Gaussians with a minimal impact on performance are masked during an optimization process.

Furthermore, for geometric attributes such as scale and rotation, the present disclosure proposes a codebook-based method to fully leverage the limited variation of these attributes.

In addition, the present disclosure uses a grid-based neural field, instead of storing them directly for each Gaussian as in an existing 3DGS, to represent color attributes.

Finally, a small number of Gaussians and compressed attributes are used in subsequent rendering steps, including projection and rasterization, to render an image.

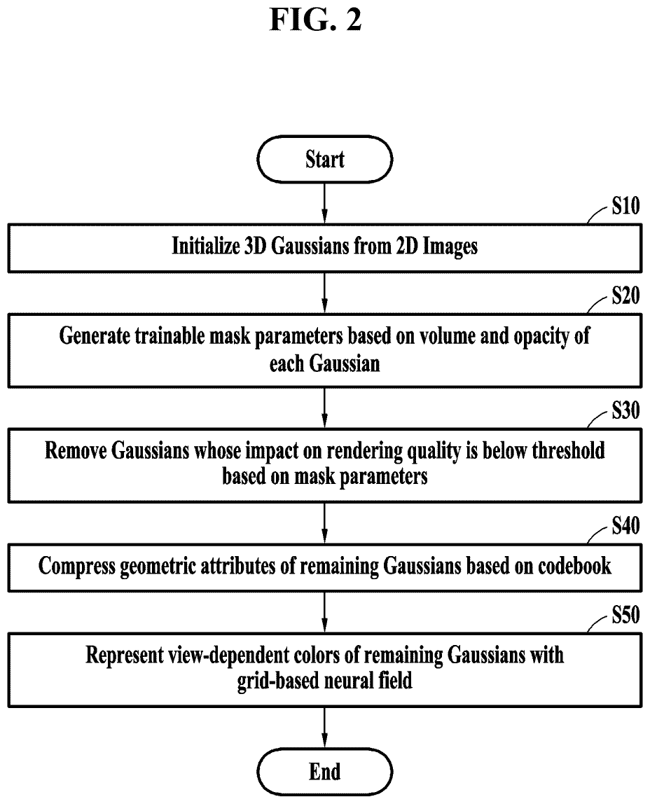

Based on this, the method for compressed 3DGS according to the present disclosure, as illustrated in FIG. 2, includes a first step S10 of initializing 3D Gaussians from a plurality of 2D images; a second step S20 of generating trainable mask parameters based on the volume and opacity of each Gaussian; a third step S30 of removing Gaussians whose impact on rendering quality is below a threshold based on the mask parameters; a fourth step S40 of compressing geometric attributes of the remaining Gaussians based on a codebook; and a fifth step S50 of representing view-dependent colors of the remaining Gaussians with a grid-based neural field.

The second step S20 generates a binary mask for a scale attribute and opacity attribute that determine the volume of each Gaussian, and calculates a masked covariance matrix and opacity based on the binary mask.

The fourth step S40 compresses scale and rotation attributes of the Gaussians using multi-stage residual vector quantization, and stores a codebook index for each stage.

The fifth step S50 constructs a hash-based multi-resolution grid structure, and trains a neural network that extracts color features using a position and view direction of a Gaussian as input.

For processing dynamic scenes, the present disclosure further includes a step of representing movement of a Gaussian over time with polynomial coefficients; a step of calculating time-conditional visibility based on a temporal center and scale; and a step of applying space-time masking to remove a Gaussian with low importance over an entire time interval.

In the dynamic scene processing, the present disclosure applies residual vector quantization to temporal features and motion coefficients for compression, and represents static color features with a grid-based neural field.

Each step of the compressed 3DGS method of the present disclosure will be described in detail as follows.

### Step S10

The first step S10 is a step of initializing 3D Gaussians, which are the basic components for representing a 3D scene, and generates initial Gaussians from sparse 3D points obtained through the Structure-from-Motion (SfM) technique.

Specifically, each 3D Gaussian is defined by the following attributes:
1) Center position (p): Coordinate values in R^{N×3} space, which represents the position of the Gaussian in 3D space
2) Opacity (o): Scalar value in [0,1]^{N} range, which determines the opacity of the Gaussian
3) 3D scale(s): Positive real value in R^{N×3}+space, which defines the magnitude of the Gaussian
4) 3D rotation (r): Quaternion value in R^{N×4} space, which determines the orientation of the Gaussian
5) Spherical harmonics coefficient (h): Value in R^{N×48} space, which represents the view-dependent color

The geometric shape of each Gaussian is represented by a covariance matrix (Σₙ), which is a positive semi-definite matrix, and is calculated by Equation 5 below.

$${Σ}_{n} = R ( {r}_{n} ) S ( {s}_{n} ) {S ( {s}_{n} )}^{T} {R ( {r}_{n} )}^{T} \qquad [ Equation 5 ]$$

where N represents the total number of Gaussians, R(⋅) is a function that generates a rotation matrix from a quaternion, and S(⋅) is a function that generates a diagonal scale matrix from a 3D scale.

This step is a process of providing base data for the subsequent masking and compression steps and directly affects the quality and efficiency of a rendering pipeline. In particular, proper initialization is important because the initialized Gaussians undergo processes of cloning, splitting, removing, and refining in subsequent steps for an accurate representation of the scene.

### Step S20

The second step is for effectively identifying and removing unnecessary Gaussians in a 3D scene representation, and in particular, provides a trainable masking method that simultaneously considers both volume and opacity.

Specifically, the second step introduces an additional mask parameter, mₙ∈R, for each Gaussian, and based on this, generates a binary mask, Mn∈{0, 1}, as shown in Equation 6 below.

$${M}_{n} = sg ( 𝕝 [ σ ( {m}_{n} ) > ϵ ] - σ ( {m}_{n} ) ) + σ ( {m}_{n} ) \qquad [ Equation 6 ]$$

where ϵ is a masking threshold, sg(⋅) is a stop-gradient operator, and 1[⋅] and σ(⋅) are an indicator function and a sigmoid function, respectively.

The generated binary mask is applied simultaneously to the scale and opacity of the Gaussian to calculate a masked covariance and opacity as in Equations 7 and 8:

$${\hat{Σ}}_{n} = R ( {r}_{n} ) S ( {M}_{n} {s}_{n} ) {S ( {M}_{n} {s}_{n} )}^{T} {R ( {r}_{n} )}^{T} \qquad [ Equation 7 ]$$

$${\hat{α}}_{n} ( x ) = {M}_{n} {o}_{n} exp ( - \frac{1}{2} {( x - {p}_{n}^{′} )}^{T} {\hat{Σ}}_{n}^{{′}^{- 1}} ( x - {p}_{n}^{′} ) ) \qquad [ Equation 8 ]$$

The description of the symbols in Equations 7 and 8 is shown in the following Table 1.

TABLE 1

| Equation 7 | | Equation 8 | |
|---|---|---|---|
| Σₙ | Covariance matrix of | αₙ(x) | Final opacity in 2D |
| | masked Gaussian | | space of masked |
| | | | Gaussian |
| R(rₙ) | Rotation matrix | Mₙ | Binary mask value for |
| | generated from | | the corresponding |
| | quaternion rn | | Gaussian |
| S(·) | Function that converts | oₙ | Base opacity value of |
| | 3D scale into diagonal | | Gaussian |
| | scale matrix | | |
| Mₙ | Binary mask value for | x | Pixel coordinate on 2D |
| | corresponding | | image |
| | Gaussian (0 or 1) | | |
| sₙ | 3D scale value of | P′ₙ | Center position of 3D |
| | Gaussian | | Gaussian projected into |
| | | | 2D |
| (·)T | Transpose operation of | Σ′⁻¹ₙ | Inverse matrix of |
| | matrix | | masked covariance |
| | | | matrix after being |
| | | | projected into 2D |

This method makes it possible to evaluate the importance of a Gaussian by considering both volume and opacity, which allows for more effective masking than considering only one aspect.

The masking of the second step is performed continuously throughout the entire training process, which enables efficient computation and low GPU memory usage throughout the training phase.

### Step S30

The third step is for efficiently reducing the number of Gaussians while maintaining rendering quality, and is intended to overcome the limitations of an existing simple opacity-based control method for 3DGS.

Specifically, the mask parameter (mₙ) generated in the second step is converted to a value between 0 and 1 through a sigmoid function, and the binary mask (Mₙ) is determined depending on whether this value is greater than a predetermined threshold (ε). This is expressed by the following Equation 9.

$${M}_{n} = sg ( 𝕝 [ σ ( {m}_{n} ) > ϵ ] - σ ( {m}_{n} ) ) + σ ( {m}_{n} ) \qquad [ Equation 9 ]$$

where sg(⋅) represents a stop-gradient operator, 1[⋅] represents an indicator function, and σ(⋅) represents a sigmoid function.

Once the binary mask is determined, it is applied to the scale and opacity of the Gaussian to calculate the masked covariance matrix (Σₙ) and opacity (αₙ) based on Equations 7 and 8 above.

This masking process is trained by optimizing a loss function composed of a combination of a rendering loss (Lren) and a masking loss (Lₘ). In particular, the masking loss is defined as in the following Equation 10.

$${L}_{m} = \frac{1}{N} {\sum }_{n = 1}^{N} σ ( {m}_{n} ) \qquad [ Equation 10 ]$$

It is noteworthy that, unlike an existing 3DGS, the present disclosure continuously performs masking throughout the entire training process without stopping densification in the middle of training. This allows for the effective removal of unnecessary Gaussians and enables efficient computation with low GPU memory throughout the training phase.

Consequently, by systematically removing Gaussians with a negligible impact on rendering quality through the third step, a reduction in the number of Gaussians of about 60% or more compared to the existing method may be achieved, while maintaining high-quality rendering performance.

### Step S40

The present inventors configured the fourth step based on the idea that when a multitude of Gaussians constitute a single scene, similar geometric components may be shared across the entire volume. In particular, it utilizes the characteristics that the geometric shapes of most Gaussians are very similar, showing only minute differences in scale and rotation, and that the scene is composed of a large number of small Gaussians, so each Gaussian primitive does not show a wide range of diversity.

In the present disclosure, a codebook stores the representative value of each group among groups of Gaussians with similar scales and rotations. In this way, while an existing method stores all the magnitude and rotation values for each of the 1,000 Gaussians even if they have similar magnitudes and rotations, the present disclosure may store only about 20 frequently occurring representative values in the codebook.

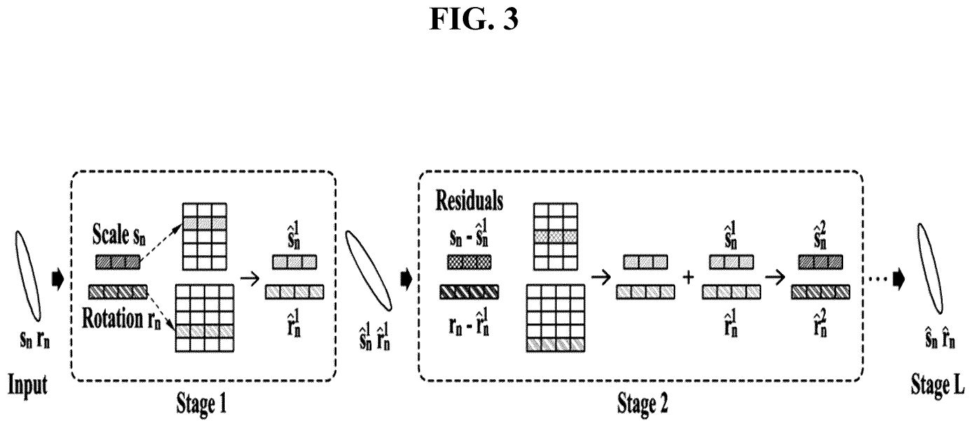

The present disclosure proposes a codebook trained to represent representative geometric attributes including scale and rotation by utilizing Vector Quantization (VQ). In particular, since simply applying vector quantization requires a high level of computational complexity and GPU memory, we adopt Residual Vector Quantization (R-VQ), which connects L stages of VQ with a codebook size C (see FIG. 3), and it is formulated as in the following Equations 11 and 12.

$${\hat{r}}_{n}^{l} = {\sum }_{i = 1}^{l} {𝒵}^{j} [ {i}_{n}^{j} ] , l ∈ \{ 1 , … , L \} \qquad [ Equation 11 ]$$

$${i}_{n}^{l} = {arg min}_{k} {‖ {𝒵}^{l} [ k ] - ( {r}_{n} - {\hat{r}}_{n}^{l - 1} ) ‖}_{2}^{2} , {\hat{r}}_{n}^{0} = \vec{0} \qquad [ Equation 12 ]$$

where rₙ∈ [symbol] ⁴ is an input rotation vector,

$${\hat{r}}_{n}^{l} ∈ {ℝ}^{4}$$

is an output rotation vector after the l-th quantization step, and n is the index of the Gaussian. z^{l}∈ [symbol] ^{C×4} is a codebook at stage 1, i^{l}∈{0, . . . C−1}^{N} is a selected codebook index at stage 1, and z|i|∈ [symbol] ⁴ represents the vector at index i of the codebook Z.

Also, the objective function for codebook training is as in the following Equation 13:

$${L}_{r} = \frac{1}{NC} {\sum }_{k = 1}^{L} {\sum }_{n = 1}^{N} {‖ sg [ {r}_{n} - {\hat{r}}_{n}^{k - 1} ] - {𝒵}^{k} [ {i}_{n}^{k} ] ‖}_{2}^{2} \qquad [ Equation 13 ]$$

where sg[⋅] is a stop-gradient operator. We use the output, r̅^{L}, of the final stage, and the R-VQ process is similarly applied to the scale s before masking (we use a similar objective function Ls for the scale as well).

Through this compression method, the present disclosure may efficiently store the geometric attributes of the Gaussian, and has the effect of additionally reducing the total storage space by about 30%. In particular, by adopting residual vector quantization instead of simple vector quantization in consideration of computational complexity and GPU memory usage, both compression efficiency and computational efficiency may be achieved simultaneously.

In addition, for training efficiency, the codebook is initialized with K-means and designed to be optimized only in the last 1K training iterations. This enables effective compression while maintaining a fast training speed.

Meanwhile, FIG. 3 is a diagram illustrating a Residual Vector Quantization (R-VQ) process for representing the scale and rotation of the Gaussian.

In the first stage, the input scale vector (sₙ) and rotation vector (rₙ) are compared with the codes in the first codebook, respectively, and the closest code is selected as a result value (sₙ¹, rₙ¹).

In the second stage, the residual vector (sₙ-s̅ₙ¹, rₙ-r̅ₙ¹), which is a difference between the original vector and the result value of the first stage, is compared with the codes of the second codebook, and the closest code is selected.

This process is repeated until the final stage (Stage L), and the original vector is represented by a combination of the codebook indexes selected at each stage and their corresponding codebooks. Here, the index selected for each stage is used as a reference value pointing to the closest code in the corresponding codebook.

Through such a multi-stage residual vector quantization structure, geometric attributes such as scale and rotation may be efficiently compressed and stored.

### Step S50

The fifth step is for solving the problem of storage space inefficiency that occurs in an existing 3DGS by storing 48 spherical harmonics coefficients for each Gaussian. In particular, its significance lies in optimizing storage space by leveraging the spatial redundancy that adjacent Gaussians may have similar color attributes.

In 3DGS, for each Gaussian, 48 out of a total of 59 parameters are needed to represent spherical harmonics (up to the 3rd degree) to model different colors depending on the viewpoint. Instead of this simple and parameter-inefficient approach, the present disclosure utilizes a grid-based neural field to represent the view-dependent color of each Gaussian.

To this end, the present disclosure contracts an infinite range of positions, p∈ [symbol] ^{N×3} into a finite range based on Mip-NeRF 360, and calculates a 3D view direction, d∈ [symbol] ³, for each Gaussian based on the camera center point. The present disclosure utilizes a small MLP after a hash grid to represent color. Here, in the present disclosure, the position is input to the hash grid, and the resulting features and the view direction are input to the MLP. More functionally, the view-dependent color cₙ(⋅) of the Gaussian at position, pₙ∈ [symbol] ³, may be expressed as in the following Equations 14 and 15:

$${c}_{n} ( d ) = f ( contract ( {p}_{n} ) , d ; θ ) , \qquad [ Equation 14 ]$$

$$contract ( {p}_{n} ) = \{ \begin{matrix}{p}_{n} & ‖ {p}_{n} ‖ \leq 1 \\ ( 2 - \frac{1}{‖ {p}_{n} ‖} ) ( \frac{{p}_{o}}{‖ {p}_{n} ‖} ) & ‖ {p}_{n} ‖ > 1\end{matrix}$$

where ƒ(⋅;θ) and contract(⋅): [symbol] ³→ [symbol] ³ represent a neural field with a parameter θ and a contraction function, respectively.

In the present disclosure, the 0-th order component of spherical harmonics (which has the same number of channels as RGB but is not view-dependent), which showed slightly improved performance over directly representing RGB colors, is represented and then converted to RGB colors.

Meanwhile, the compressed 3DGS method of the present disclosure, for processing dynamic scenes, may further include (i) a step of representing movement of the Gaussian over time with polynomial coefficients, (ii) a step of calculating time-conditional visibility based on a temporal center and scale, and (iii) a step of applying space-time masking to remove a Gaussian with low importance over an entire time interval.

This will be described in more detail as follows.

The aforementioned compressed Gaussian representation may be extended to dynamic scenarios. The present disclosure uses STG, a state-of-the-art method for dynamic scenes, as a baseline model. STG is designed to train space-time Gaussian attributes, such as polynomial coefficients of degree noₚ for position

$${\{ {u}_{n , k} ∈ {ℝ}^{3} \}}_{k = 1}^{{no}_{p}}$$

and degree noᵣ for rotation

$${\{ {v}_{n , k} ∈ {ℝ}^{4} \}}_{k = 1}^{{no}_{r}} ,$$

and a temporal center and scale μₙ, ξₙ∈ [symbol] , as well as static (time-independent) attributes such as position spₙ, rotation srₙ, scale sₙ, opacity oₙ, and color feature scₙ.

STG introduces a temporal center, μₙ∈ [symbol] , to model the time-conditional attributes of each Gaussian, which is the time step at which each Gaussian is most prominent. The motion of each Gaussian is represented by training polynomial coefficients for position

$${\{ {u}_{n , k} ∈ {ℝ}^{3} \}}_{k = 1}^{{no}_{p}}$$

and rotation

$${\{ {v}_{n , k} ∈ {ℝ}^{4} \}}_{k = 1}^{{no}_{r}} .$$

At any given time t, the position pₙ(⋅)∈ [symbol] ³ and rotation rₙ(⋅)∈ [symbol] ⁴ are defined as in Equation 15:

$${p}_{n} ( t ) = {sp}_{n} + {\sum }_{k = 1}^{{no}_{p}} {{u}_{n , k} ( t - {μ}_{n} )}^{k} \qquad [ Equation 15 ]$$

$${r}_{n} ( t ) = {sr}_{n} + {\sum }_{k = 1}^{{no}_{r}} {{v}_{n , k} ( t - {μ}_{n} )}^{k}$$

where spₙ∈ [symbol] ³, srₙ∈ [symbol] ⁴ are the canonical position and rotation at t=μₙ, and noₚ, noᵣ are the maximum polynomial degrees for position and rotation (STG sets noₚ=3 and noᵣ=1). STG keeps the scale attribute

$${s}_{n} ∈ {ℝ}_{+}^{3}$$

of each Gaussian constant over time. Therefore, the covariance matrix at time t may be written as in the following Equation 16:

$${Σ}_{n} ( t ) = R ( {r}_{n} ( t ) ) S ( {s}_{n} ) {S ( {s}_{n} )}^{T} {R ( {r}_{n} ( t ) )}^{T} \qquad [ Equation 16 ]$$

For time-conditional visibility, STG uses a temporal radial basis function, so that the final projected opacity αₙ(⋅,⋅) of each Gaussian at a pixel and time coordinates (x, t) may be written as in the following Equation 17:

$${α}_{n} ( x , t ) = {o}_{n} ( t ) exp ( - \frac{1}{2} {( x - {p}_{n}^{′} ( t ) )}^{T} {Σ}_{n}^{t - 1} ( t ) ( x - {p}_{n}^{′} ( t ) ) ) \qquad [ Equation 17 ]$$

$${α}_{n} ( t ) = {so}_{n} exp ( - {ξ}_{n} {\vert t - {μ}_{n} \vert}^{2} ) .$$

where soₙ∈[0,1] represents a time-independent spatial opacity, ξₙ∈ [symbol] represents a temporal scale indicating the effective duration of each Gaussian (i.e., the period of high temporal opacity), and

$${p}_{n}^{′} ( ∘ ) , {Σ}_{n}^{′} ( ∘ )$$

are a projected center position and covariance at each timestamp.

STG optimizes a 9-dimensional feature, scₙ∈ [symbol] ⁹, for each Gaussian to represent spatial, view-directional, and temporal colors in three dimensions each, and constructs the time-varying color feature, cₙ(t)∈ [symbol] ⁹, of each Gaussian as in the following Equation 18:

$${c}_{n} ( t ) = stack ( {sc}_{n , 1 : 6} , ( t - {μ}_{n} ) {sc}_{n , 7 : 9} ) \qquad [ Equation 18 ]$$

where sc_{n,1:6} is a column vector extracted from the first to the sixth elements of the color feature vector scₙ, and the stack(⋅, ⋅) operator stacks input vectors into a single vector.

This feature is splatted into the image space through the projection and rasterization process, and the splatted feature F(⋅,⋅) may be formulated as in the following Equation 19:

$$F ( x , t ) = {\sum }_{k = 1}^{𝒩 ( x , t )} {c}_{k} ( t ) {α}_{k} ( x , t ) {\prod }_{j = 1}^{k - 1} ( 1 - {α}_{j} ( x , t ) ) \qquad [ Equation 19 ]$$

where [symbol] (x,t) is the number of Gaussians around x at time t, and the Gaussians are sorted based on depth according to the view direction. The splatted feature, F(x,t), is then split into F(x,t)_{1:3}, F(x,t)_{4:6}, and F(x,t)_{7:9}, which represent spatial, view-directional, and temporal color features, respectively, and the final RGB color C(⋅,⋅) at a pixel and time coordinates (x, t) may be obtained as in Equation 20:

$$C ( x , t ) = {F ( x , t )}_{1 : 3} + ϕ ( {F ( x , t )}_{4 : 6} , {F ( x , t )}_{7 : 9} , d ) \qquad [ Equation 20 ]$$

where d∈ [symbol] ³ is the view direction, and φ(⋅,⋅,⋅) is an MLP for view- and time-dependent colors.

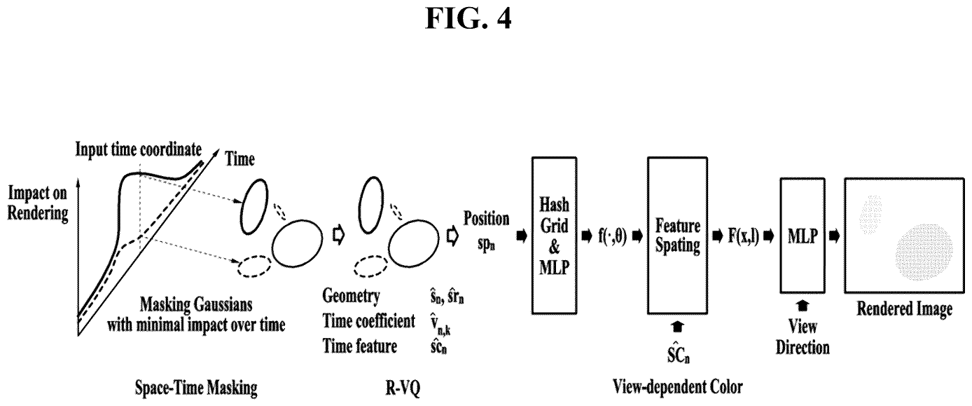

Meanwhile, to remove redundant Gaussians in dynamic scenes, the present disclosure considers not only the spatial impact of each Gaussian but also the temporal impact thereof. In the present disclosure, as shown in FIG. 4, a masking strategy is extended to simultaneously estimate two types of importance by optimizing a per-Gaussian mask to reflect its impact on rendering quality over time. Specifically, in the present disclosure, the binary mask of Equation 6 is applied to the time-varying covariance (Equation 16) and opacity (Equation 17), and is reconstructed as in Equation 21:

$${\hat{Σ}}_{n} ( t ) = R ( {r}_{n} ( t ) ) S ( {M}_{n} {s}_{n} ) {S ( {M}_{n} {s}_{n} )}^{T} {R ( {r}_{n} ( t ) )}^{T} \qquad [ Equation 21 ]$$

$${\hat{o}}_{n} ( t ) = {M}_{n} {o}_{n} exp ( - {ξ}_{n} {\vert t - {μ}_{n} \vert}^{2} ) .$$

In the context of static scenes, several methods have proposed estimating and removing non-essential Gaussians as a post-training process, showing promising results. However, applying these techniques to dynamic scenes presents a greater challenge as it requires evaluating the effect of each Gaussian over the entire time period. On the other hand, our proposed masking strategy avoids this complexity, thus simplifying the process. It trains the actual rendering impact of each Gaussian across all timestamps during training iterations via gradient descent.

Meanwhile, the present disclosure implements an efficient representation for Gaussian attributes using R-VQ and a neural field according to the redundancy and continuity of the attributes.

Furthermore, the present disclosure applies R-VQ to the time-invariant geometric attributes (from sₙ, srₙ to ŝₙ, \hat{r}ₙ) to leverage their redundancy. Also, since temporal features show redundancy over time, we also use R-VQ for the rotation coefficients \hat{v}_{n,k} and the temporal feature \tilde{s}c_{n,7:9}. However, since position requires high precision in 3D space and is already compressively represented using a polynomial basis, no further compression is applied to the coefficients v_{n,k}.

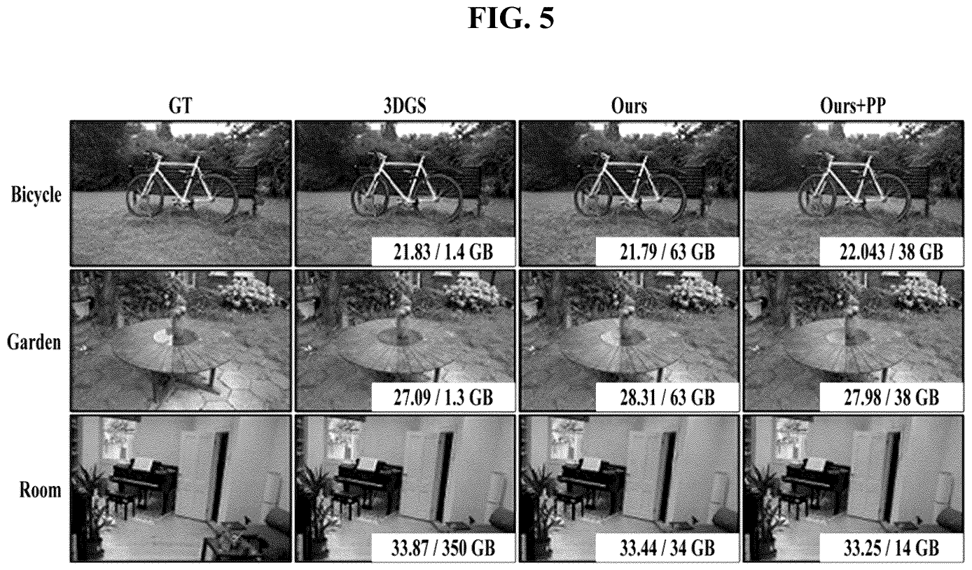

For static color attributes, the present disclosure similarly leverages the continuity of colors. We use the neural field, ƒ(⋅;θ): [symbol] ³→ [symbol] ⁶, to represent the spatial and view-directional color feature, sc_{n,1:6}∈ [symbol] ⁶, at each canonical position spₙ, so the final color feature, cₙ(t), may be reconstructed as in Equation 22.

$${c}_{n} ( t ) = stack ( f ( contract ( {sp}_{n} ) ; θ ) , ( t - {μ}_{n} ) s {\hat{c}}_{n} \qquad [ Equation 22 ]$$

where ŝcₙ∈ [symbol] ³ is the temporal color feature to which R-VQ has been applied. Following STG, the present disclosure splats this feature, cₙ(t) into the image space and uses an MLP to obtain the final color, as illustrated in FIG. 5.

Another embodiment of the present disclosure relates to a computing device that implements the above-described compressed 3DGS method.

FIG. 5 is a block diagram illustrating the schematic configuration of a computing device, which is a reconfiguration of the above-described series of configurations from the perspective of a hardware configuration. Therefore, only a brief overview will be given here, focusing on the function and operation of each component, to avoid redundant explanations.

A computing device 800 is configured to include a memory 830 that stores a program 820 coded for a computer to read the above-described compressed 3DGS method, and a processor 810 that executes the program.

Meanwhile, the compressed 3DGS method of the above-described embodiment may be implemented as computer-readable code on a computer-readable recording medium. The computer-readable recording medium includes any kind of recording device on which data readable by a computer system is stored.

The present disclosure can automatically identify and remove Gaussians with little impact on rendering quality during a training process through a trainable volume masking technique, thereby reducing the total number of Gaussians by 60% or more compared to an existing method while maintaining high-quality rendering performance. In particular, effective masking is possible even in dynamic scenes by simultaneously evaluating importance in space-time.

In addition, the present disclosure can efficiently represent Gaussians that share similar scale and rotation values through codebook-based compression of geometric attributes. By utilizing residual vector quantization (R-VQ), a high compression rate can be achieved while lowering computational complexity, which has the effect of additionally reducing storage space by about 30%.

Furthermore, the present disclosure, with its view-dependent color representation method utilizing a grid-based neural field, can significantly reduce the number of parameters compared to an existing spherical harmonics coefficient method. This is possible by replacing the storage of 48 parameters for each Gaussian with a shareable grid structure.

Consequently, the present disclosure achieves a storage space reduction of 25 times or more for static scenes and 12 times or more for dynamic scenes compared to the existing method, while also showing an effect of improved rendering speed. These technical effects enable practical application in various application fields that require real-time 3D rendering.

Examples of the computer-readable recording medium include ROM, RAM, CD-ROMs, magnetic tapes, floppy disks, optical data storage devices, and the like. In addition, the computer-readable recording media may be distributed over network-coupled computer systems so that the computer-readable code is stored and executed in a distributed fashion. And, functional programs, codes, and code segments for implementing the present disclosure can be easily inferred by programmers skilled in the art to which the present disclosure pertains.

The present disclosure has been described above with a focus on its various embodiments. Those of ordinary skill in the art to which the present disclosure pertains will understand that the present disclosure may be embodied in modified forms without departing from its essential characteristics. Therefore, the disclosed embodiments should be considered from a descriptive point of view rather than a limiting one. The scope of the present disclosure is shown not in the foregoing description but in the claims, and all differences within the equivalent scope should be construed as being included in the present disclosure.

### STATEMENT REGARDING PRIOR DISCLOSURES BY THE INVENTOR OR A JOINT INVENTOR

Some of the inventors of the present application have made related disclosures in (1) Joo Chan Lee et al., “Compact 3D Gaussian Representation for Radiance Field,” IEEE/CVF on Nov. 22, 2023; and (2) Joo Chan Lee et al., “Compact 3D Gaussian Splatting for Static and Dynamic Radiance Fields,” arXiv PREPRINT on Aug. 7, 2024. The related disclosures were made less than one year before the effective filing date (Nov. 21, 2024) of the present application, and the present application names additional persons as joint inventors relative to the persons named as authors in the related disclosures. Accordingly, it is apparent that the related disclosures each are a grace period inventor disclosure and, thus the related disclosures are disqualified as prior art under 35 USC 102(a)(1) against the present application. See 35 USC 102(b)(1)(A) and MPEP 2153.01(a).

What is claimed is:

1. A method for compressed 3D Gaussian Splatting (3DGS), the method comprising:
a first step of initializing 3D Gaussians from multi-view 2D images;
a second step of generating trainable mask parameters based on a volume and opacity of each Gaussian;
a third step of removing Gaussians whose impact on rendering quality is below a threshold based on the mask parameters;
a fourth step of compressing geometric attributes of remaining Gaussians based on a codebook; and
a fifth step of representing view-dependent colors of the remaining Gaussians with a grid-based neural field.

2. The method according to claim 1, wherein the second step comprises:
generating a binary mask for a scale attribute and opacity attribute that determine the volume of each Gaussian; and
calculating a masked covariance matrix and opacity based on the binary mask.

3. The method according to claim 1, wherein the fourth step comprises:
compressing scale and rotation attributes of the Gaussians using multi-stage residual vector quantization; and
storing a codebook index for each stage.

4. The method according to claim 1, wherein the fifth step comprises:
constructing a hash-based multi-resolution grid structure; and
training a neural network that extracts color features using a position and view direction of a Gaussian as input.

5. The method according to claim 1, further comprising, for processing a dynamic scene:
representing movement of a Gaussian over time with polynomial coefficients;
calculating time-conditional visibility based on a temporal center and a scale; and
applying space-time masking to remove a Gaussian with low importance over an entire time interval.

6. The method according to claim 5, wherein, in the dynamic scene processing,
residual vector quantization is applied to temporal features and motion coefficients for compression; and
static color features are represented with a grid-based neural field.

7. A computer-readable recording medium having recorded thereon a program coded for a computer to execute the method for compressed 3D Gaussian Splatting (3DGS) according to claim 1.

8. A computing device, comprising:
a memory for storing a program coded for a computer to execute a method for compressed 3D Gaussian Splatting (3DGS); and
a processor for executing the program,
wherein the method comprises:
a first step of initializing 3D Gaussians from multi-view 2D images;
a second step of generating trainable mask parameters based on a volume and opacity of each Gaussian;
a third step of removing Gaussians whose impact on rendering quality is below a threshold based on the mask parameters;
a fourth step of compressing geometric attributes of remaining Gaussians based on a codebook; and
a fifth step of representing view-dependent colors of the remaining Gaussians with a grid-based neural field.

9. The computing device according to claim 8, wherein the second step comprises:
generating a binary mask for a scale attribute and opacity attribute that determine the volume of each Gaussian; and
calculating a masked covariance matrix and opacity based on the binary mask.

10. The computing device according to claim 8, wherein the fourth step comprises:
compressing scale and rotation attributes of the Gaussians using multi-stage residual vector quantization; and
storing a codebook index for each stage.

11. The computing device according to claim 8, wherein the fifth step comprises:
constructing a hash-based multi-resolution grid structure; and
training a neural network that extracts color features using a position and view direction of a Gaussian as input.

12. The computing device according to claim 8, further comprising, for processing a dynamic scene:
representing movement of a Gaussian over time with polynomial coefficients;
calculating time-conditional visibility based on a temporal center and a scale; and
applying space-time masking to remove a Gaussian with low importance over an entire time interval.

13. The computing device according to claim 12, wherein, in the dynamic scene processing,
residual vector quantization is applied to temporal features and motion coefficients for compression; and
static color features are represented with a grid-based neural field.
